(19) United States
(12) Patent Application Publication
(10) Pub. No.: US 2007/0100775 A1
(43) Pub. Date: May 3, 2007

(54) Method for estimating the cost of a future project

(75) Inventor: Bhavin J. Vyas, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/261,565

(22) Filed: Oct. 31, 2005

(51) Int. Cl. G06F 17/00

(52) U.S. Cl. 705/400

(57) ABSTRACT

A computer system for estimating the cost of a future project is disclosed. The computer system has a console, at least one input device, and a central processing unit in communication with the console and the at least one input device. The central processing unit is configured to receive one or more parameters of a future project via the at least one input device and determine an equipment solution that satisfies the parameters of the future project. The central processing unit is also configured to analyze historic data automatically collected by equipment encompassed by the equipment solution and estimate a cost of implementing the equipment solution to complete the future project, based on the analysis. The central processing unit is further configured to calculate the cost of the future project based on the estimated cost of implementing the equipment solution.

### TECHNICAL FIELD

This disclosure relates generally to a method for determining the cost of a project and, more particularly, to a method for determining the cost of a future project based on automatically-collected historic data.

### BACKGROUND

In the construction, maintenance, repair, and service industries, new projects require significant resources. These resources may include personnel, time, materials, facilities, equipment, and other resources known in the art. The availability of these resources may depend on a significant amount of financial investment and may have an associated amount of risk. The companies or other organizations that fund these projects or provide these services may desire to know the associated cost of investment, before committing the necessary resources.

The cost of investing in a new project is typically determined based on historic data manually gathered from past similar projects. This historic data could include information such as equipment cost, resale value of the equipment after completion of the project, total equipment operator cost, total fuel cost, total repair cost, insurance cost, etc. By assessing this information, an overall cost of the new project may be estimated. However, the conditions at one project location may vary over time, or may be very different from another project location, causing inaccuracies in the cost estimation.

One method that has been developed for improving the accuracy of an estimated cost associated with an intangible project is described in U.S. Patent Publication No. 2002/0138394 (the '394 publication) of Elliot printed on Sep. 26, 2002. The '394 publication describes a method of doing business that includes generating statistics data related to the new project location such as local labor rates, local cost for uniforms, local cost for equipment, local cost of supplies, local union regulations, etc. The method further includes calculating an estimated cost of providing the requested service based on the location-specific statistics data.

Although the method of the '394 publication may improve the accuracy of cost estimation by factoring in location-specific cost parameters, it may be limited and labor intensive. In particular, because the statistics data used in the method of the '394 publication does not include information related to the current operational condition of the equipment or operating parameters of the equipment affected by the location of the new project, the accuracy of the estimated cost may be inadequate. In addition, because the statistics data described in the '394 publication must be manually collected, the method of the '394 publication may be time consuming and inefficient.

The method of the present disclosure is directed towards overcoming one or more of the problems as set forth above.

### SUMMARY OF THE INVENTION

In accordance with one aspect, the present disclosure is directed toward a method for determining the cost of a future project. The method includes receiving one or more parameters of a future project and determining an equipment solution that satisfies the parameters of the future project. The method also includes analyzing historic data automatically collected by equipment encompassed by the equipment solution and estimating a cost of implementing the equipment solution to complete the future project, based on the analysis. The method further includes calculating the cost of the future project based on the estimated cost of implementing the equipment solution.

According to another aspect, the present disclosure is directed toward a computer system including a console, at least one input device, and a central processing unit in communication with the console and the at least one input device. The central processing unit is configured to receive one or more parameters of a future project via the at least one input device and determine an equipment solution that satisfies the parameters of the future project. The central processing unit is also configured to analyze historic data automatically collected by equipment encompassed by the equipment solution and estimate a cost of implementing the equipment solution to complete the future project, based on the analysis. The central processing unit is further configured to calculate the cost of the future project based on the estimated cost of implementing the equipment solution.

In accordance with yet another aspect, the present disclosure is directed toward a computer readable medium for use on a computer system. The computer readable medium has computer executable instructions for performing a method, including receiving one or more parameters of a future project and determining an equipment solution that satisfies the parameters of the future project. The method also includes analyzing historic data automatically collected by equipment encompassed by the equipment solution and estimating a cost of implementing the equipment solution to complete the future project, based on the analysis. The method further includes calculating the cost of the future project based on the estimated cost of implementing the equipment solution.

### BRIEF DESCRIPTION OF THE DRAWINGS

FIG. 1 is a schematic and diagrammatic illustration of an exemplary disclosed work machine;

FIG. 2 is a block illustration of an exemplary disclosed computer system for use with the work machine of FIG. 1; and

FIG. 3 is a flowchart illustration of an exemplary disclosed method of operating the computer system of FIG. 2.

### DETAILED DESCRIPTION

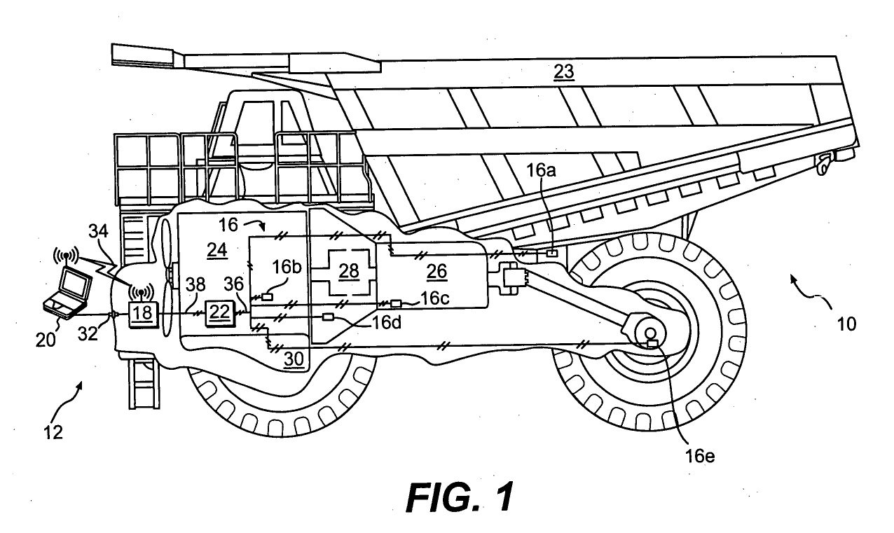

FIG. 1 illustrates a work machine 10 having an exemplary disclose data acquisition system 12. Work machine 10 may embody a stationary or mobile machine configured to perform some type of operation associated with an industry such as mining, construction, farming, transportation, power generation, or any other industry known in the art. For example, work machine 10 may be an earth moving machine such as a haul truck,.a dozer, a loader, a backhoe, an excavator, a motor grader, or any other earth moving machine. Work machine 10 may alternatively embody a stationary generator set, pumping mechanism, or any other suitable operation-performing work machine.

Data acquisition system 12 may include components that cooperate to automatically gather information from work machine 10 during operation of work machine 10. For example, data acquisition system 12 may include an interface module 16, a communication module 18, and a controller 22 configured to communicate with an off-board system 20 via communication module 18. It is contemplated that one or more of interface module 16, communication module 18, and controller 22 may be integrated as a single unit. It is further contemplated that data acquisition system 12 may include additional or different components than those illustrated in FIG. 1.

Interface module 16 may include a plurality of sensing devices 16a-e distributed throughout work machine 10 and configured to gather data from various components and subsystems of work machine 10. Sensing devices 16a-e may be associated with a work implement 23, a power source 24, a transmission 26, a torque converter 28, a fluid supply 30, and/or other components and subsystems of work machine 10. These sensing devices 16a-e may be configured to automatically gather data from the components and subsystems of work machine 10 such as, for example, implement, engine, and/or work machine speed or location; fluid pressure, flow rate, temperature, contamination level, and/or viscosity; electric current and/or voltage levels; fluid (i.e., fuel, oil, etc.) consumption rates; loading levels (i.e., payload value, percent of maximum allowable payload limit, payload history, payload distribution, etc.); transmission output ratio; cycle time; grade; performed maintenance and/or repair operations; and other such pieces of information. Additional information may be generated or maintained by interface module 16 such as, for example, time of day, date, and operator information. Each of the gathered pieces of information may be indexed relative to the time, day, date, operator information, or other pieces of information to trend the various operational aspects of work machine 10.

Communication module 18 may include any device that is configured to facilitate communications between controller 22 and off-board system 20. Communication module 18 may include hardware and/or software that enables communication module 18 to send and/or receive data messages through a direct data link 32 or a wireless communication link 34. The wireless communications may include satellite, cellular, infrared, and any other type of wireless communications that enable controller 22 to wirelessly exchange information with off-board system 20.

Controller 22 may include any means for monitoring, recording, storing, indexing, processing, and/or communicating the operational aspects of work machine 10 described above. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from types of computer program products or computer-readable media, such as computer chips and secondary storage devices, including hard disks, floppy disks, optical media, CD-ROM, or other forms of RAM or ROM.

Controller 22 may be in communication with the other components of data acquisition system 12. For example, controller 22 may be in communication with interface module 16 and with communication module 18 via communication lines 36 and 38, respectively. Various other known circuits may be associated with controller 22 such as, for example, power supply circuitry, signal-conditioning circuitry, solenoid driver circuitry, communication circuitry, and other appropriate circuitry.

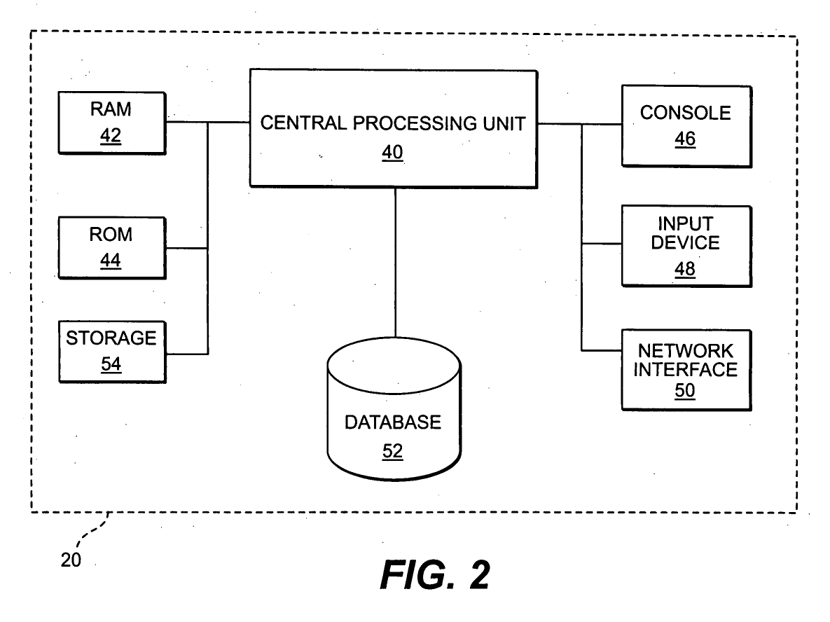

Off-board system 20 may represent one or more computing systems of a business entity associated with work machine 10, such as a manufacturer, dealer, retailer, owner, or any other entity that generates, maintains, sends, and/or receives information associated with work machine 10. The one or more computing systems may include, for example, a laptop, a work station, a personal digital assistant, a mainframe, and other computing systems known in the art. As illustrated in FIG. 2, off-board system 20 may include a central processing unit (CPU) 40, a random access memory (RAM) 42, a read-only memory (ROM) 44, a console 46, an input device 48, a network interface 50, a database 52, and a storage 54. It is contemplated that off-board system 20 may include additional; fewer, and/or different components than what is listed above. It is understood that the type and number of listed devices are exemplary only and not intended to be limiting.

CPU 40 may execute sequences of computer program instructions to perform various processes that will be explained below. The computer program instructions may be loaded into RAM 42 for execution by CPU 40 from ROM 44.

Storage 54 may embody any appropriate type of mass storage provided to store any type of information CPU 40 may need to perform the processes. For example, storage 54 may include one or more hard disk devices, optical disk devices, or other storage devices that provide storage space.

Off-board system 20 may interface with a user via console 46, input device 48, and network interface 50. In particular, console 46 may provide a graphics user interface (GUI) to display information to users of off-board system 20. Console 46 may be any appropriate type of computer display device or computer monitor. Input device 48 may be provided for users to input information into off-board system 20. Input device 48 may include, for example, a keyboard, a mouse, or other optical or wireless computer input devices. Further, network interface 50 may provide communication connections such that off-board system 20 may be accessed remotely through computer networks.

Database 52 may contain model data and any information related to data records under analysis. Database 52 may also include analysis tools for analyzing the information within database 52. CPU 40 may use database 52 to determine historic relations or trends relating to fluid consumption rates; work machine repair and/or maintenance history; loading, stresses, and/or wear on components of work machine 10; hours of use, and other such pieces of real time machine usage information.

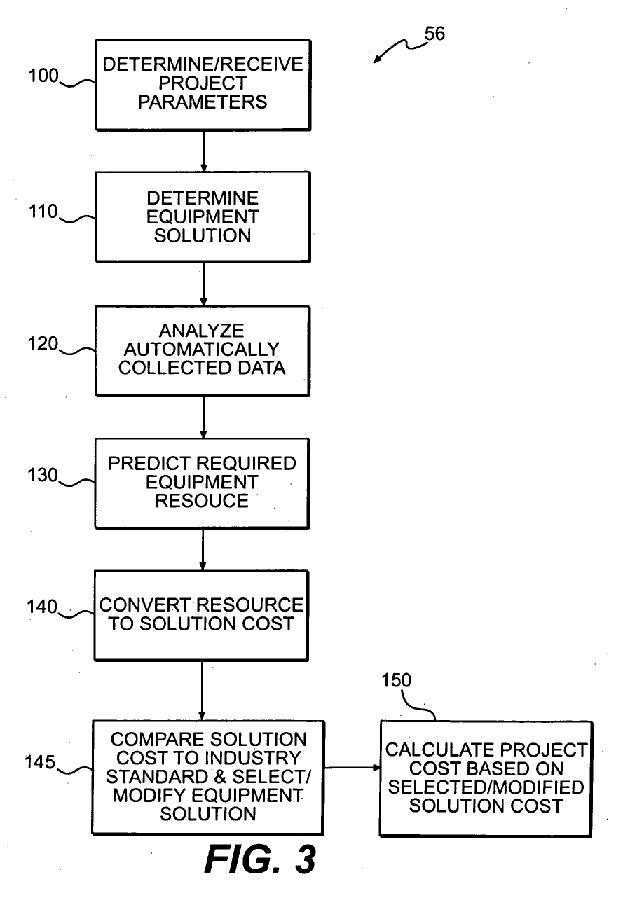

FIG. 3 illustrates a flowchart 56 depicting an exemplary method that utilizes off-board system 20 to determine a cost of a future project based on the historical relations or trends determined by CPU 40 . It is contemplated that the method may alternatively be implemented manually without the use of off-board system 20. The method depicted in flowchart 56 will be described in more detail below.

### INDUSTRIAL APPLICABILITY

The disclosed method and system may provide a way to accurately determine the cost of a future project. In particular, the disclosed method and system maybe used to determine an equipment solution to the future project and the associated required resources based on real time or historic data automatically collected by a work machine. In this manner, a potential investor in the future project may determine the magnitude of investment required to successfully complete the future project, before committing to the project.

As illustrated in FIG. 3, the first step in determining the cost of a future project may include determining or receiving parameters of the future project (Step 100). These parameters may be input to CPU 40 via input device 48 or communicated to CPU 40 via network interface 50 and may include, for example, specific project information. The specific project information may include, among other things, a job type (e.g., a digging operation, a clearing operation, a leveling operation, a hauling operation, a drilling operation, a dozing operation, etc.,) a geographical profile of the project area (e.g., acreage, required profile or dimension, grade, soil composition, typical weather condition, elevation, noise or emission regulations, etc.), a timeline for project scheduling (e.g., allowable operation times, required start of project, required completion date, etc.), and/or any other such project parameters. It is contemplated that CPU 40 may alternatively determine one or more of these parameters as a function of one or more other input parameters.

Upon determination or receipt of the project parameter information, an equipment solution may be determined that satisfies the parameters (Step 110). An equipment solution may include the use of one or more work machines 10 of various types, sizes, quantities, capabilities, etc. to complete the future project according to the parameters described above. For example, an equipment solution to an excavation project could include one or more hydraulic excavators working in tandem with a dozer or wheel loader to fill a series of haul trucks within a predetermined period of time. Work machines 10 encompassed by the equipment solution may be provided in varying quantities and sizes, and operated at predetermined times of the day for predetermined periods of time by particular operators based on the specific project parameters. For any particular project, multiple equipment solutions may be provided depending upon the predefined project parameters. Similarly, it is contemplated that for certain projects, only one equipment solution may be available based on the predefined project parameters.

Once the equipment solution has been determined, historic data automatically collected during a previous project by the same equipment encompassed by the solution to the future project may be analyzed to predict operation of the equipment during completion of the future project (Step 120). In the example of the excavation project described above, historic data automatically captured and/or generated by data acquisition system 12 for the hydraulic excavators, dozer or wheel loader, and the series of haul trucks may be analyzed. The analysis may include, for example, a comparison of the previous project's parameters to the future project's parameters, and the inherent relationship to the associated operational aspects or trends of the same work machines 10 collected during completion of the previous project. These same aspects can then be predicted for the work machines 10 encompassed by the equipment solution of the future project according to the inherent relationship . Ideally, the historic data collected from one work machine 10 may be used to predict the operational aspects of the same work machine 10 at the same work location.

For example, if the project area of the future excavation project is larger than the project area of a previous excavation project and the soil composition is more abrasive, it can be expected that the amount of fuel required by the work machines 10 to complete the future project may increase; tire, track, or implement wear may increase; additional repairs may be required; and the operational and/or maintenance time of each work machine 10 may increase. The amount of increase may be proportional to the increase in the project's parameters (e.g., project area and soil abrasiveness in the excavation example above). In addition, trends associated with each of the captured operational aspects of each work machine 10 may indicate an increasing or decreasing need for repair or maintenance that may be manifested during completion of the future project, or may be used to predict an impending component failure or other potential problem associated with the future project. The history of these operational aspects and the corresponding trends automatically captured or generated by data acquisition system 12 may be used to predict the operational resources (i.e., fuel, oil, water, etc.), repair resources, maintenance resources, replacement resources or other related resources required during the implementation of the equipment solution (Step 130). These predictions may then be converted by CPU 40 to an equipment solution cost or cost of completing the future project with the associated equipment solution (Step 140).

Once the equipment solution cost has been determined, this cost may be compared with an industry standard and selected for the project or modified based on the comparison (Step 145). Specifically, the cost of implementing the equipment solution determined from step 110 described above may be greater than other available solutions. Other available solutions might include rental equipment, the purchase of new equipment or technology, manual labor, and other such solutions known in the art. The cost of these other available solutions may be determined according to conventional methods. Then, if the equipment solution determined from step 110 above is more expensive to implement than the other available solutions, the equipment solution may be modified or replaced with other available solutions to generate a lower overall equipment solution cost.

The cost of the future project may be calculated as a function of the estimated cost of implementing the selected or modified equipment solution (Step 150). That is, in addition to the conventionally estimated cost of materials and labor associated with the future project, the cost of the equipment solution may be included in the final tally. Because the cost of the final project takes into account data automatically collected during previous projects performed by the same work machine(s) 10 that are intended for the future project, the estimated cost of implementing the equipment solution may be very accurate. In addition, when the automatically collected data is collected at the same job site location as that of the future project, thereby taking into account location-specific relationships, the accuracy can be increased even more. Further, because the data is automatically collected, the process may be inexpensive and efficient.

It is contemplated that once the cost of the final project has been determined and approved for implementation, CPU 40 may automatically schedule the resources necessary to implement the equipment solution. In particular, upon acceptance of a bid proposal, for example, CPU 40 may automatically arrange for the transportation, repair, maintenance, service, operation, and other such tasks associated with the use of equipment encompassed by the equipment solution. CPU 40 may also automatically gather data from the equipment during operation and compare the actual operational aspects, historical trends, and associated costs to the previously predicted values to track the accuracy of the process.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A method for determining the cost of a future project, comprising:
receiving one or more parameters of a future project;
determining an equipment solution that satisfies the parameters of the future project;
analyzing historic data automatically collected by equipment encompassed by the equipment solution;
estimating a cost of implementing the equipment solution to complete the future project, based on the analysis; and
calculating the cost of the future project based on the estimated cost of implementing the equipment solution.

2. The method of claim 1, wherein:
the historic data includes a maintenance history of the equipment; and
estimating a cost includes predicting a maintenance cost of the. equipment during completion of the future project based on the maintenance history.

3. The method of claim 2, wherein the maintenance history includes the replacement history of at least one of a traction device and a work implement.

4. The method of claim 1, wherein:
the historic data includes a repair history of the equipment; and
estimating a cost includes predicting a repair cost of the equipment during completion of the future project based on the repair history.

5. The method of claim 1, wherein:
the historic data includes monitored operational aspects of the equipment; and
estimating the cost includes estimating a cost of operating the equipment during completion of the future project.

6. The method of claim 5, wherein the monitored operational aspects include a load history of the equipment.

7. The method of claim 6, wherein estimating the cost includes comparing the load history to a load threshold limit.

8. The method of claim 5, wherein the monitored operational aspects include a fluid consumption history of the equipment.

9. The method of claim 5, wherein the monitored operational aspects include a fluid contamination history of the equipment.

10. The method of claim 1, wherein estimating the cost includes estimating a life of the equipment and the cost of replacement equipment.

11. The method of claim 1, wherein estimating the cost includes depreciating the value of the equipment during completion of the future project.

12. The method of claim 1, wherein analyzing historic data includes analyzing historic data taken from equipment operated at the same geographic location as the future project.

13. The method of claim 1, further including:
comparing the estimated cost of implementing the equipment solution to an industry standard associated with the equipment solution; and
modifying the equipment solution according to the comparison.

14. A computer system, comprising:
a console;
at least one input device; and
a central processing unit in communication with the console and the at least one input device, the central processing unit configured to:
receive one or more parameters of a future project via the at least one input device;
determine an equipment solution that satisfies the parameters of the future project;
analyze historic data automatically collected by equipment encompassed by the equipment solution;
estimate a cost of implementing the equipment solution to complete the future project, based on the analysis; and
calculate the cost of the future project based on the estimated cost of implementing the equipment solution.

15. The computer system of claim 14, wherein:
the historic data includes a maintenance history of the equipment; and
estimating a cost includes predicting a maintenance cost of the equipment during completion of the future project based on the maintenance history.

16. The computer system of claim 15, wherein the maintenance history includes the replacement history of at least one of a traction device and a work implement.

17. The computer system of claim 14, wherein
the historic data includes a repair history of the equipment; and
estimating a cost includes predicting a repair cost of the equipment during completion of the future project based on the repair history.

18. The computer system of claim 14, wherein:
the historic data includes monitored operational aspects of the equipment; and
estimating the cost includes estimating a cost of operating the equipment during completion of the future project.

19. The computer system of claim 18, wherein the monitored operational aspects include at least one of a load history, a fluid consumption history, and a fluid contamination history of the equipment.

20. The computer system of claim 14, wherein estimating the cost includes:
estimating a life of the equipment and the cost of replacement equipment; and
depreciating the value of the equipment during completion of the future project.

21. The computer system of claim 14, wherein the historic data includes data taken from equipment operated at the same geographic location as the future project.

22. The computer system of claim 14, wherein the central processing unit is further configured to:
compare the estimated cost of implementing the equipment solution to an industry standard associated with the equipment solution; and
modify the equipment solution according to the comparison.

23. A computer readable medium for use on a computer system, the computer readable medium having computer executable instructions for performing a method comprising:
receiving one or more parameters of a future project;
determining an equipment solution that satisfies the parameters of the future project;
analyzing historic data automatically collected by equipment encompassed by the equipment solution;
estimating a cost of implementing the equipment solution to complete the future project, based on the analysis; and
calculating the cost of the future project based on the estimated cost of implementing the equipment solution.

24. The computer readable medium of claim 23, wherein:
the historic data includes a maintenance history of the equipment; and
estimating a cost includes predicting a maintenance cost of the equipment during completion of the future project based on the maintenance history.

25. The computer readable medium of claim 24, wherein the maintenance history includes the replacement history of at least one of a traction device and a work implement.

26. The computer readable medium of claim 23, wherein
the historic data includes a repair history of the equipment; and
estimating a cost includes predicting a repair cost of the equipment during completion of the future project based on the repair history.

27. The computer readable medium of claim 23, wherein:
the historic data includes at least one of a load history, a fluid consumption history, and a fluid contamination history of the equipment; and
estimating the cost includes estimating a cost of operating the equipment during completion of the future project.

28. The computer readable medium of claim 23, wherein estimating the cost includes:
estimating a life of the equipment and the cost of replacement equipment; and
depreciating the value of the equipment during completion of the future project.

29. The computer readable medium of claim 23, wherein analyzing historic data includes analyzing historic data taken from the equipment operated at the same geographic location as the future project.

30. The computer readable medium of claim 23, wherein the method further includes:
comparing the estimated cost of implementing the equipment solution to an industry standard associated with the equipment solution; and
modifying the equipment solution according to the comparison.
